(19) United States
(12) Patent Application Publication
(10) Pub. No.: US 2016/0123722 A1
(43) Pub. Date: May 5, 2016

(54) COMPUTING DEVICE AND METHOD FOR ANALYZING THICKNESS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Chih-Kuang CHANG, New Taipei (TW); Xin-Yuan WU, Shenzhen (CN)

(21) Appl. No.: 14/734,704

(22) Filed: Jun. 9, 2015

(30) Foreign Application Priority Data
Nov. 4, 2014 (CN) 201410614825.2

(51) Int. Cl. G01B 11/06

(52) U.S. Cl. CPC G01B 11/06

(57) ABSTRACT

A computing device and a method analyze thickness of an object. The computing device obtains a point cloud of an object from a scanner coupled to the computing device. The computing device triangulates the point cloud of the object using a plurality of triangles. The computing device obtains thickness information of the object according to the triangulated point cloud of the object and generates a report according to the thickness information of the object.

### CROSS-REFERENCE TO RELATED APPLICATIONS

This application claims priority to Chinese Patent Application No. 201410614825.2 filed on Nov. 4, 2014, the contents of which are incorporated by reference herein.

### FIELD

The subject matter herein generally relates to point cloud technology, and particularly to a computing device and a method for analyzing thickness of an object.

### BACKGROUND

A product (e.g., a mobile phone) includes a plurality of accessories (e.g., a shell, a screen, and a battery). During manufacturing, if thickness of each accessory does not fall with a predetermined error range, a plurality of accessories may not be assembled into a single product.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a thickness analysis system included in the computing device.

FIG. 3 shows a diagrammatic view of an example of an object.

FIG. 4 shows a diagrammatic view of an example of triangulating a point cloud of the object.

FIG. 5 shows a diagrammatic view of an example of a triangulated point cloud of the object with a plurality of triangles.

FIG. 6 shows a diagrammatic view of an example of searching for forward triangles and reverse triangles from the triangulated point cloud of the object.

FIG. 7 shows a diagrammatic view of an example of assigning a color to each triangle.

FIG. 8 shows a diagrammatic view of an example of a report which shows thickness information of the object.

FIG. 9 is a flowchart of an example embodiment of a method for analyzing thickness.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

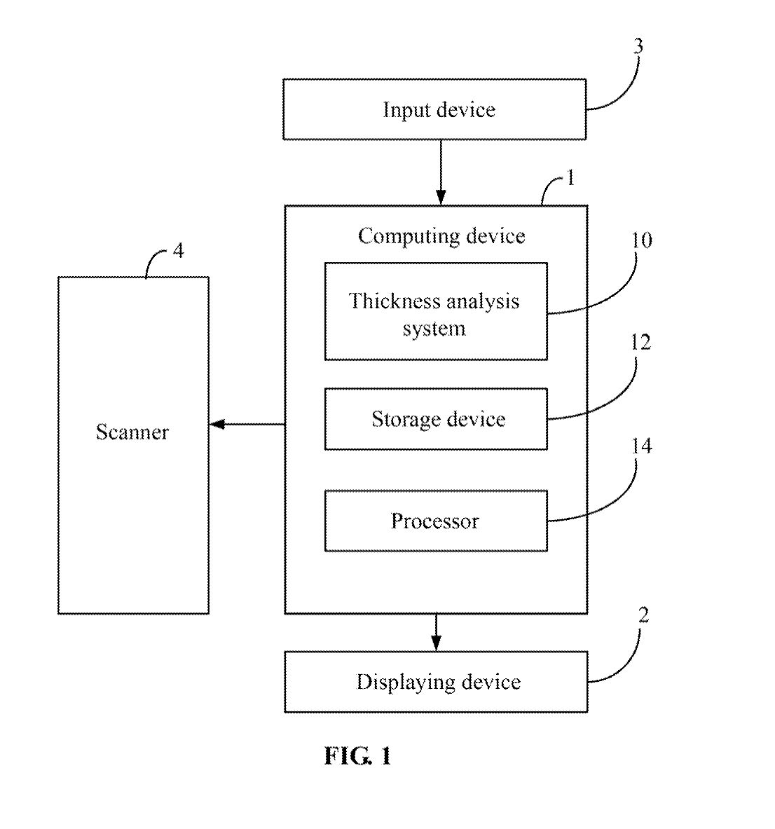

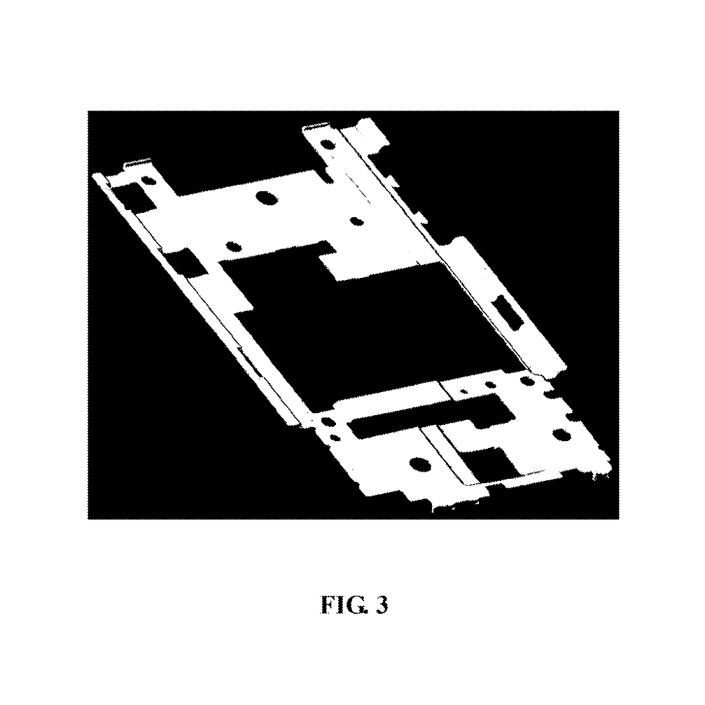

FIG. 1 illustrates a block diagram of an example embodiment of a computing device 1. In the embodiment, the computing device 1 provides various functional connections to connect with a displaying device 2, an input device 3, and a scanner 4. The computing device 1 provides a user interface, which is displayed on the displaying device 2. One or more operations of the computing device 1 can be controlled by a user through the user interface. For example, the user may input an ID and a password using the input device 3 (e.g., a keyboard and a mouse) into the user interface to access the computing device 1. The scanner 4 is used to scan a surface of an object to obtain a point cloud of the object. The point cloud is three-dimensional and includes a plurality of points. That is, each point in the point cloud includes an X-axis value, a Y-axis value and a Z-axis value. The displaying device 2 further displays the point cloud of the object, so that the point cloud of the object can be visually checked by the user. The computing device 1 can be, but is not limited to, a tablet computer, a server, a personal computer or any other computing device. The scanner 4 can be, but is not limited to, a three-dimensional scanner capable of emitting light which is projected onto the object. The scanner 4 includes one or more charge coupled devices (CCD) 40 and a platform. The CCD 40 is used to scan the object to obtain a point cloud of the object which is located on the platform of the scanner 4. The object may be, but is not limited to, a component (e.g., a shell) of an electronic device (e.g., a shell of a mobile phone), as shown in FIG. 3. In the example embodiment, the computing device 1 includes, but is not limited to, a thickness analysis system 10, a storage device 12, and at least one processor 14. FIG. 1 illustrates only one example of the computing device 1, and other examples can comprise more or fewer components than those shown in the embodiment, or have a different configuration of the various components.

In at least one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1. The storage device 12 stores the three-dimensional point cloud of the object scanned by the scanner 4.

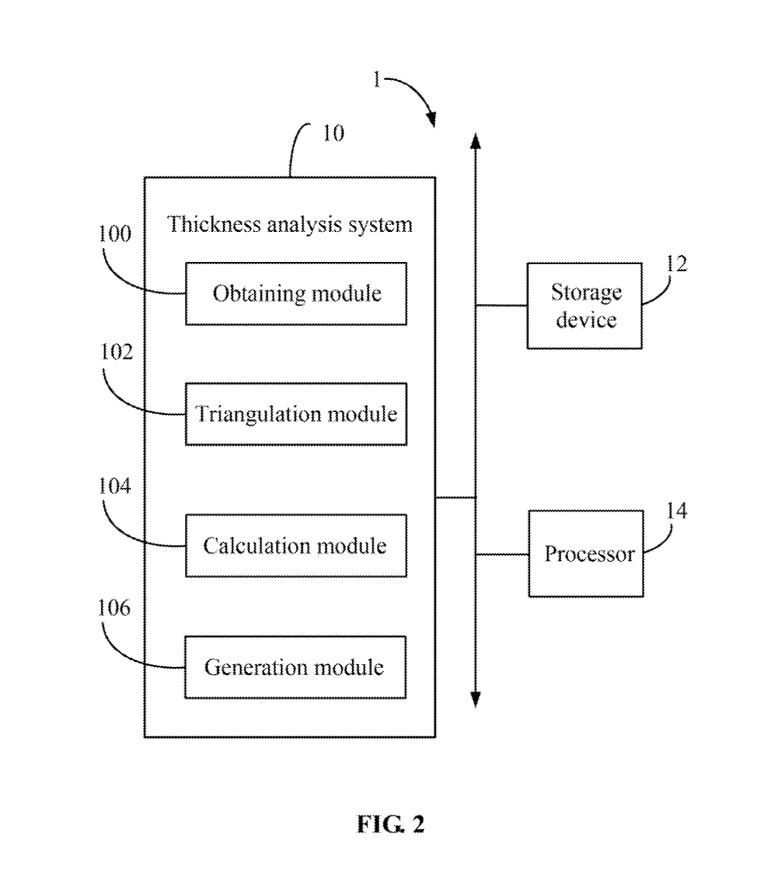

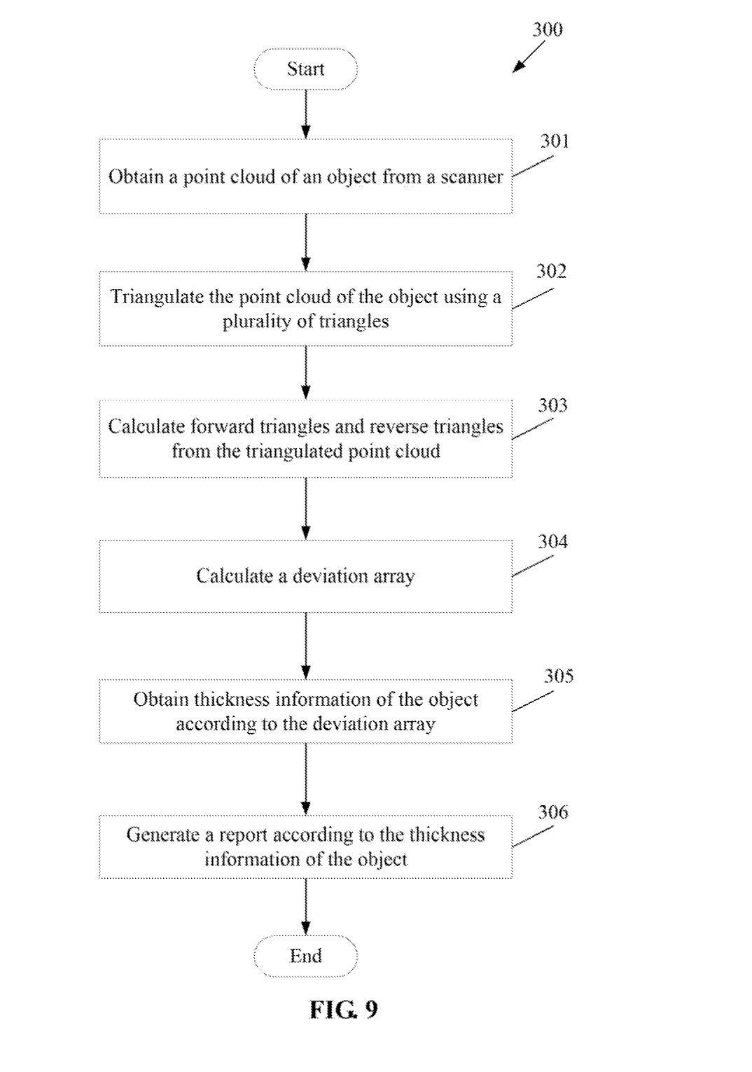

FIG. 2 illustrates a block diagram of an example embodiment of the thickness analysis system 10 included in the computing device 1. In at least one embodiment, the thickness analysis system 10 can include, but is not limited to, an obtaining module 100, a triangulation module 102, a calculation module 104, and a generation module 106. The modules 100-106 can comprise computerized instructions in the form of one or more computer-readable programs that can be stored in a non-transitory computer-readable medium, such as the storage device 12, and be executed by the at least one processor 14 of the computing device 1. Detailed descriptions of functions of the modules are given below in reference to FIG. 9.

FIG. 9 illustrates a flowchart of an example embodiment of a method for analyzing thickness of an object. In an example embodiment, the method is performed by execution of computer-readable software program codes or instructions by at least one processor of a computing device.

Referring to FIG. 9, a flowchart is presented in accordance with an example embodiment. The method 300 is provided by way of example, as there are a variety of ways to carry out the method. The method 300 described below can be carried out using the configurations illustrated in FIGS. 1 and 9, for example, and various elements of these figures are referenced in explaining example method 300. Each block shown in FIG. 9 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

In block 301, the obtaining module obtains point cloud of the object scanned by the scanner 4.

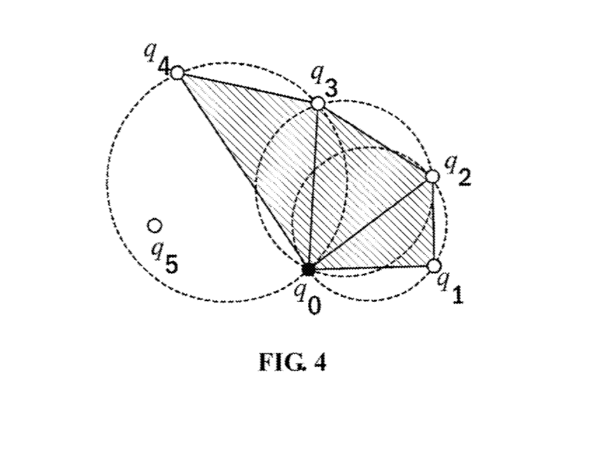

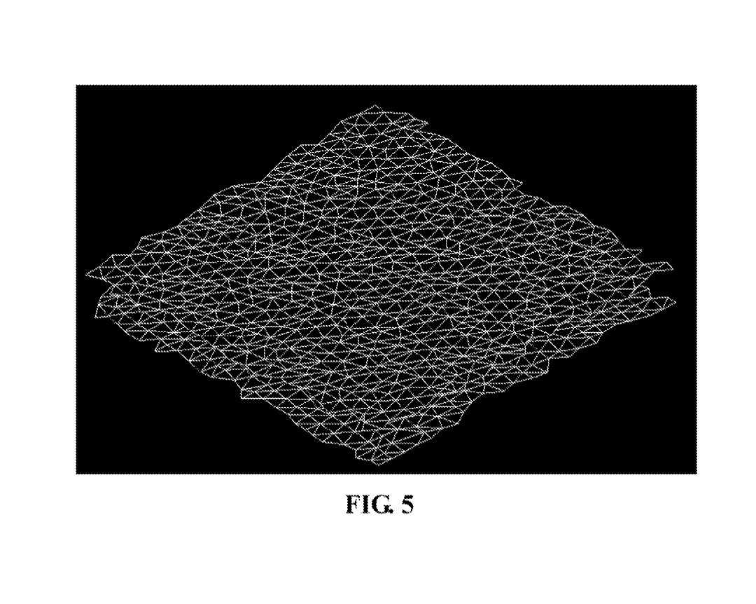

In block 302, the triangulation module triangulates the point cloud of the object using a plurality of triangles. In at least one embodiment, the point cloud of the object can be represented by the plurality of triangles after triangulation. Each triangle is determined to be qualified when the triangle meets two following conditions: (1) there are no any points inside a circumcircle of the triangle, and (2) an angle between a vector of the triangle and another vector of each adjacent triangle does not exceed a predetermined curvature (e.g., a 90 degrees), where the adjacent triangle and the triangle shares the same line. For example, as shown in FIG. 4, another point q5 locates inside the circumcircle of the triangle which is generated by the points q0, q3 and q4, then the triangle q0-q3-q4 does not meet the first condition (1) and the triangle q0-q3-q4 is determined to be unqualified. As yet shown in FIG. 4, the triangle q0-q2-q3 and the triangle q0-q1-q2 meet the first condition (1), both the triangle q0-q2-q3 and the triangle q0-q1-q2 include the same line q0-q2, the triangle q0-q1-q2 are determined as the adjacent triangle respect with the triangle q0-q2-q3. Further, if the angle between the vector of the triangle q0-q2-q3 and the vector of the triangle q0-q1-q2 does not exceed a predetermined curvature, the triangle q0-q2-q3 meets the second condition (2) and is determined to be qualified. In additions, there are still a huge of qualified triangles after triangulation, some qualified triangles are discarded for simplifying later calculation. For example, if a curvature of the qualified triangle falls in a first predetermined range (e.g., 70 degrees to 90 degrees), the qualified triangle is kept. If a curvature of the qualified triangle falls in a second predetermined range (e.g., 0 degree to 10 degrees), the qualified triangle is randomly selected to be kept, for example, a predetermined percentage (30%) of the qualified triangles which the curvature of each qualified triangle falls in a range of 0 degree to 10 degrees are randomly selected to be kept. As shown in FIG. 5, the point cloud of the object includes a plurality of triangles after triangulation.

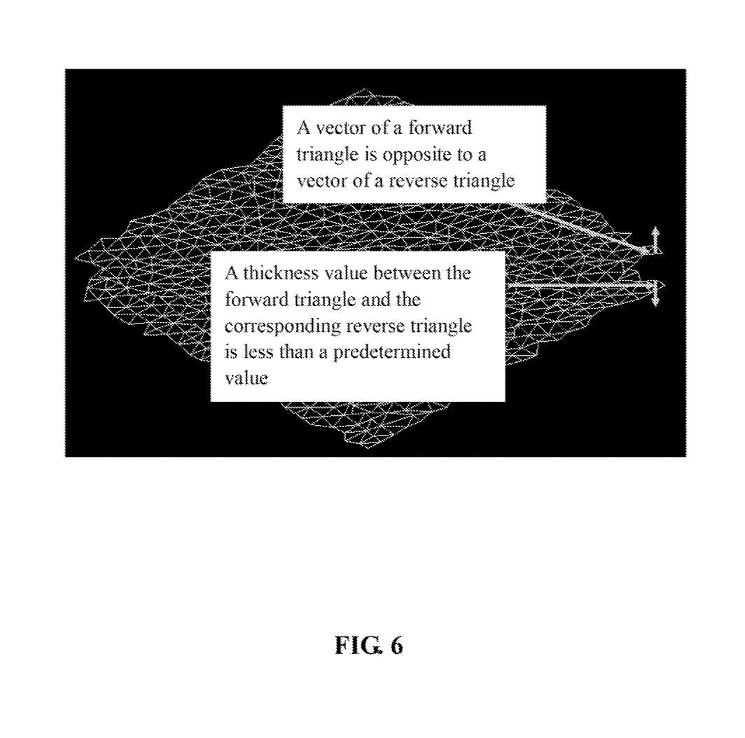

In block 303, the calculation module calculates forward triangles and reverse triangles from the triangulated point cloud. Each forward triangle is related to a reverse triangle when two following conditions are met: (1) a vector of the forward triangle is opposite to a vector of the corresponding reverse triangle, for example as shown in FIG. 6, the vector of the forward triangle points to a upward direction, the vector of the corresponding reverse triangle points to a downward direction, and (2) a thickness value between the forward triangle and the corresponding reverse triangle is less than a predetermined value, for example, a half nanometer, one nanometer, two nanometers or the like. The thickness value between the forward triangle and the corresponding reverse triangle is a distance from a center point of the forward triangle to a center point of the corresponding reverse triangle.

In block 304, the calculation module calculates a deviation array according to the forward triangles and reverse triangles. The deviation array includes a plurality of deviation values. Each deviation value is calculated by the predetermined value and the thickness value between the forward triangle and the corresponding reverse triangle. That is, a deviation value is equal to the predetermined value minus the thickness value between the forward triangle and the corresponding reverse triangle.

In block 305, the calculation module obtains thickness information of the object according to the deviation array. The thickness information of the object includes an average value of all thickness values from the deviation array, a maximum value of all thickness values from the deviation array, a minimum value of all thickness values from the deviation array, and a standard value of the all thickness values from the deviation array. The standard value is calculated by a formula as follows:

$$S = \sqrt{\frac{\sum {( x - \overline{x} )}^{2}}{n - 1}} ,$$

where, S is the standard value, n is the number of the thickness values, x is the thickness value from the deviation array, and x̅ is the average value of all thickness values from the deviation array.

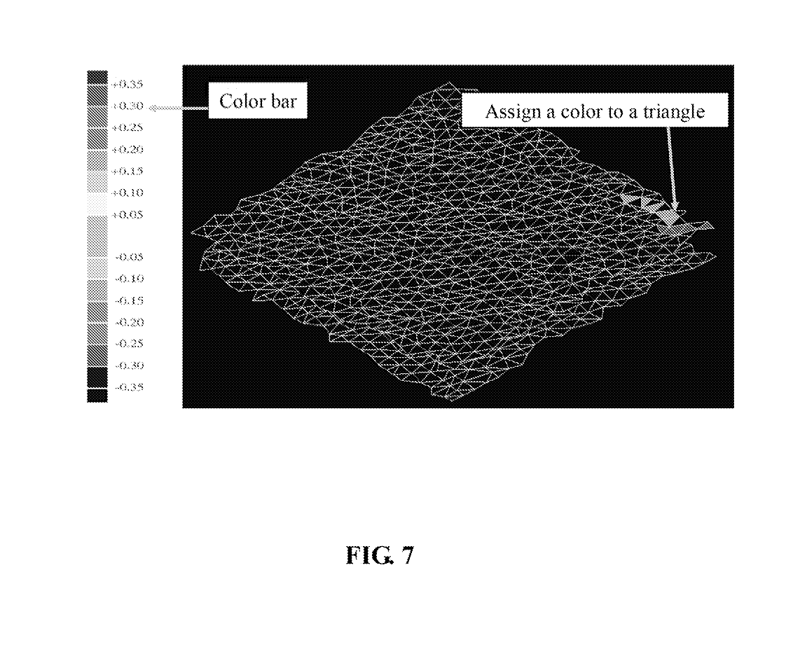

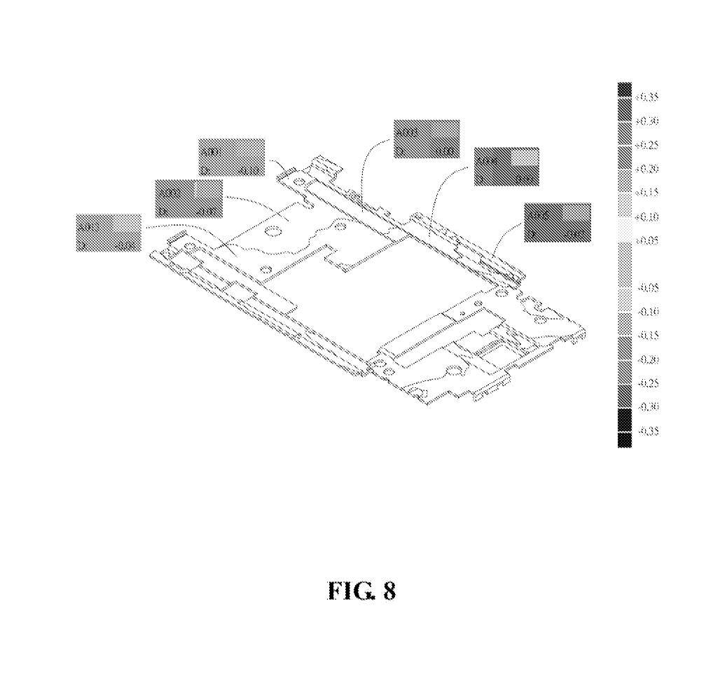

In block 306, the generation module generates a report according to the thickness information of the object. As shown in FIGS. 7-8, the report is the point cloud of the object having colors and deviation values assigned to triangles of the point cloud of the object. In at least one embodiment, the report can be saved as a format (e.g., a drawing interchange format, a TXT format) into the storage device 12, and also can be displayed on the displaying device 2 connected to the computing device 1. As shown in FIG. 7, the report further includes a color bar, and the color bar includes one or more colors. Each color shown in the color bar is defined for distinguishing a tolerance range. The tolerance range is defined for an area of the object having a tolerance in a predetermined tolerance range. For example, blue-black is assigned to a first tolerance range [−0.14 mil, −0.12 mil], bright-yellow is assigned to a second tolerance range [+0.12 mil, +0.14 mil]. Each triangle of the point cloud of the object is assigned a color according to the deviation value corresponding to the triangle. For example, if the deviation value corresponding to the triangle falls within the first tolerance range [−0.14 mil, −0.12 mil], the blue-black is assigned to the triangle. It is easier for a user to distinguish the tolerance ranges in the report by the color. The user can distinguish the tolerance ranges in the point cloud of the object according to the colors of the color bar.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores one or more programs, which when executed by the at least one processor, cause the at least one processor to:
obtain a point cloud of an object scanned by a scanner coupled to the computing device by scanning the object with the scanner;
triangulate the point cloud of the object using a plurality of triangles;
calculate forward triangles and reverse triangles from the triangulated point cloud of the object;
calculate a deviation array according to the forward triangles and the reverse triangles;
obtain thickness information of the object according to the deviation array; and
generate a report according to the thickness information of the object.

2. The computing device of claim 1, wherein each of the triangles is determined to be qualified when the triangle meets two conditions: (1) there are no any points inside a circumcircle of the triangle, and (2) an angle between a vector of the triangle and another vector of each adjacent triangle does not exceed a predetermined curvature, and the adjacent triangle and the triangle shares the same line.

3. The computing device of claim 1, wherein each of the forward triangles is related to a reverse triangle when two following conditions are met: (1) a vector of the forward triangle is opposite to a vector of the corresponding reverse triangle, and (2) a thickness value between the forward triangle and the corresponding reverse triangle is less than a predetermined value.

4. The computing device of claim 3, wherein the thickness value between the forward triangle and the corresponding reverse triangle is a distance from a center point of the forward triangle to a center point of the corresponding reverse triangle.

5. The computing device of claim 3, wherein the deviation array comprises a plurality of deviation values, and each of the deviation values is calculated by the predetermined value and the thickness value between the forward triangle and the corresponding reverse triangle.

6. The computing device of claim 1, wherein the thickness information of the object comprises an average value of all thickness values from the deviation array, a maximum value of all thickness values from the deviation array, a minimum value of all thickness values from the deviation array, and a standard value of the all thickness values from the deviation array.

7. The computing device of claim 1, wherein the report is the point cloud of the object having colors and deviation values assigned to triangles of the point cloud of the object.

8. A computer-based quality assurance testing method for items of manufacture, the method comprising:
placing the item of manufacture on a scanning platform;
scanning the item of manufacture with a scanner coupled to a computing device to obtain a point cloud of the item of manufacture;
triangulating the obtained point cloud of the scanned item of manufacture using a plurality of triangles;
calculating from the triangulated point cloud forward triangles and reverse triangles relative the item of manufacture;
calculating measurements of the scanned item of manufacture from the forward triangles and the reverse triangles;
comparing calculated measurements of the scanned item of manufacture to preset specifications for the item of manufacture;
calculating a deviation array for the scanned item of manufacture based on the calculated measurements of the scanned item of manufacture and the preset specifications for the item of manufacture.

9. The method of claim 8, wherein each of the triangles is determined to be qualified when the triangle meets two conditions: (1) there are no any points inside a circumcircle of the triangle, and (2) an angle between a vector of the triangle and another vector of each adjacent triangle does not exceed a predetermined curvature, and the adjacent triangle and the triangle shares the same line.

10. The method of claim 8, wherein each of the forward triangles is related to a reverse triangle when two following conditions are met: (1) a vector of the forward triangle is opposite to a vector of the corresponding reverse triangle, and (2) a thickness value between the forward triangle and the corresponding reverse triangle is less than a predetermined value.

11. The method of claim 10, wherein the thickness value between the forward triangle and the corresponding reverse triangle is a distance from a center point of the forward triangle to a center point of the corresponding reverse triangle.

12. The method of claim 10, wherein the deviation array comprises a plurality of deviation values, and each of the deviation values is calculated by the predetermined value and the thickness value between the forward triangle and the corresponding reverse triangle.

13. The method of claim 8, wherein the measurements of the scanned item of manufacture comprises an average value of all thickness values from the deviation array, a maximum value of all thickness values from the deviation array, a minimum value of all thickness values from the deviation array, and a standard value of the all thickness values from the deviation array.

14. The method of claim 8, wherein a report is generated for the point cloud of the object having colors and deviation values assigned to triangles of the point cloud of the object.

15. A non-transitory computer-readable medium having stored thereon instructions that, when executed by at least one processor of a computing device, causing the computing device to perform a method for analyzing thickness, the method comprising:
obtaining a point cloud of an object scanned by a scanner coupled to the computing device by scanning the object with the scanner;
triangulating the point cloud of the object using a plurality of triangles;
calculating forward triangles and reverse triangles from the triangulated point cloud of the object;
calculating a deviation array according to the forward triangles and the reverse triangles;
obtaining thickness information of the object according to the deviation array; and
generating a report according to the thickness information of the object.

16. The non-transitory computer-readable medium of claim 15, wherein each of the triangles is determined to be qualified when the triangle meets two conditions: (1) there are no any points inside a circumcircle of the triangle, and (2) an angle between a vector of the triangle and another vector of each adjacent triangle does not exceed a predetermined curvature, and the adjacent triangle and the triangle shares the same line.

17. The non-transitory computer-readable medium of claim 15, wherein each of the forward triangles is related to a reverse triangle when two following conditions are met: (1) a vector of the forward triangle is opposite to a vector of the corresponding reverse triangle, and (2) a thickness value between the forward triangle and the corresponding reverse triangle is less than a predetermined value.

18. The non-transitory computer-readable medium of claim 17, wherein the thickness value between the forward triangle and the corresponding reverse triangle is a distance from a center point of the forward triangle to a center point of the corresponding reverse triangle.

19. The non-transitory computer-readable medium of claim 17, wherein the deviation array comprises a plurality of deviation values, and each deviation value is calculated by the predetermined value and the thickness value between the forward triangle and the corresponding reverse triangle.

20. The non-transitory computer-readable medium of claim 15, wherein the thickness information of the object comprises an average value of all thickness values from the deviation array, a maximum value of all thickness values from the deviation array, a minimum value of all thickness values from the deviation array, and a standard value of the all thickness values from the deviation array.
